(19) United States
(12) Patent Application Publication
(10) Pub. No.: US 2012/0217872 A1
(43) Pub. Date: Aug. 30, 2012

(54) Luminaire

(76) Inventor: David Bruce Eeles, Giffard Park (GB)

(21) Appl. No.: 13/391,392

(22) PCT Filed: Aug. 12, 2010
(86) PCT No.: PCT/GB10/01518

§ 371 Date: May 16, 2012

Related U.S. Application Data
(60) Provisional application No. 61/240,143, filed on Sep. 4, 2009.

(51) Int. Cl. H01J 7/26; H01Q 1/26; H01J 25/50

(52) U.S. Cl. 315/34; 315/112; 315/39.51

(57) ABSTRACT

A luminaire has a light source in the form of a quartz crucible, having a plasma void. A power supply has a magnetron for providing microwaves for generating a plasma in the void. An air wave guide is connected below the magnetron and a connector is connected below the wave guide. The plasma crucible is fitted to the bottom of the connector and is enclosed by a Faraday cage. Arranged with the crucible at its focal point is a reflector. It has a central aperture through which the connector extends. A lower, hemispherical shell of a casing for the power supply supports the reflector at a similar aperture, with the interposition of one or more focus adjusting spacers.

The present invention relates to a luminaire.

A luminaire is a term used to mean a complete lighting unit, in particular including a light source and a light director, normally a reflector. Luminaires can be wall, roof or post mounted.

We have filed a series of patent applications on our Light Emitting Resonator of which the first to be published is under International/PCT No WO2009/063205, published on 22^{nd} May 2009. Below, we refer to this as “Our LER Application”. It describes and claims a light source to be powered by microwave energy, the source having:
a solid plasma crucible of material which is transparent or translucent for exit therefrom, the plasma crucible having a sealed void in the plasma crucible,
a Faraday cage surrounding the plasma crucible, the cage being at least partially light transmitting for light exit from the plasma crucible, whilst being microwave enclosing,
a fill in the void of material excitable by microwave energy to form a light emitting plasma therein, and
an antenna arranged within the plasma crucible for transmitting plasma-inducing microwave energy to the fill, the antenna having:
   a connection extending outside the plasma crucible for coupling to a source of microwave energy;
      the arrangement being such that light from a plasma in the void can pass through the plasma crucible and radiate from it via the cage.

Whilst initially we envisaged our LER light source as being powered by microwaves and involving resonance of them in the plasma crucible, we now envisage its use over a wide frequency range and with non-resonant devices.

High Frequency (HF) plasma is a term often applied to mean both Radio Frequency, RF (≈1-300 MHz) and Microwave (≈0.3-300 GHz) excited plasmas.

The object of the present invention is to provide an improved luminaire for use with an HF Plasma light source.

According to the invention there is provided a luminaire having:
a plasma light source powered by High Frequency (HF) power;
a HF power supply having a physical structure,
   the light source and the HF-power-supply physical structure being connected together as an assembly;
a housing for the HF power supply, the said assembly and the housing being fastened together and the housing having:
   an aperture through which the said assembly extends with cooling air flow clearance and
   a cooling air fan arranged at an opening in the housing for drawing air in (or out) for cooling of the HF power supply and passage out (or in) via the aperture and past the light source; and
a reflector for at least substantially collimating light from the light source fastened to the housing at the aperture and the reflector having its own aperture through which the said assembly extends, with the light source arranged within the reflector.

Preferably the reflector has a set back portion extending back towards the said assembly from the reflector's fastening position on the housing.

Further, the luminaire preferably includes one or more spacers between the reflector and the housing at the reflector's fastening position on the housing for adjusting focus of the collimated light.

Normally a cooling duct will be provided from the fan to the HF-power-supply physical structure.

In the preferred embodiment, the HF-power-supply physical structure is the casing of a magnetron. In this embodiment, a matching circuit is provided between the HF power supply and the light source, the matching circuit having its own physical structure included in the said assembly. A connector is also provided between the matching circuit and the light source, the connector having its own physical structure included in the said assembly.

Preferably, the luminaire includes:
luminaire supporting means fast with the housing and
means for supporting the said assembly from the luminaire supporting means via the housing.

The luminaire supporting means can be an eye fast with the housing at an upper region of the housing. Further, the means for supporting the said assembly can comprise a sub-frame interconnecting the assembly and the housing, the sub-frame being connected to the assembly at the HF-power-supply physical structure.

Alternatively, the luminaire can include:
luminaire supporting means fast with the said assembly and
means for supporting the housing from the luminaire supporting means.

In this case, the luminaire supporting means can be an eye fast an invert U member fast with the assembly. Further, the means for supporting the said housing comprises a sub-frame interconnecting the housing and the assembly, the sub-frame being connected to the assembly at the HF-power-supply physical structure.

The sub-frame can be connected to the housing at a junction between and upper and lower parts of the housing; or wherein the sub-frame can be connected to the housing at the reflector's fastening position on the housing.

Normally the HF power supply will include a drive circuit for the HF power supply and means for supporting the drive circuit with the HF-power-supply physical structure Conveniently where the sub-frame is provided, the drive circuit supporting means can be this.

Whilst the invention is not intended to be restricted to such a light source, in the preferred embodiment, it is LER light source and the power supply is a magnetron. Thus in this embodiment, the light source has:
a solid plasma crucible of material which is transparent or translucent for exit therefrom, the plasma crucible having a sealed void in the plasma crucible,
a Faraday cage surrounding the plasma crucible, the cage being at least partially light transmitting for light exit from the plasma crucible, whilst being microwave enclosing,
a fill in the void of material excitable by microwave energy to form a light emitting plasma therein, and
an antenna arranged within the plasma crucible for transmitting plasma-inducing microwave power to the fill;
   the arrangement being such that:
light from a plasma in the void can pass through the plasma crucible and radiate from it via the cage to the reflector and
cooling air flows past the crucible.

To help understanding of the invention, a specific embodiment thereof will now be described by way of example and with reference to the accompanying drawings, in which:

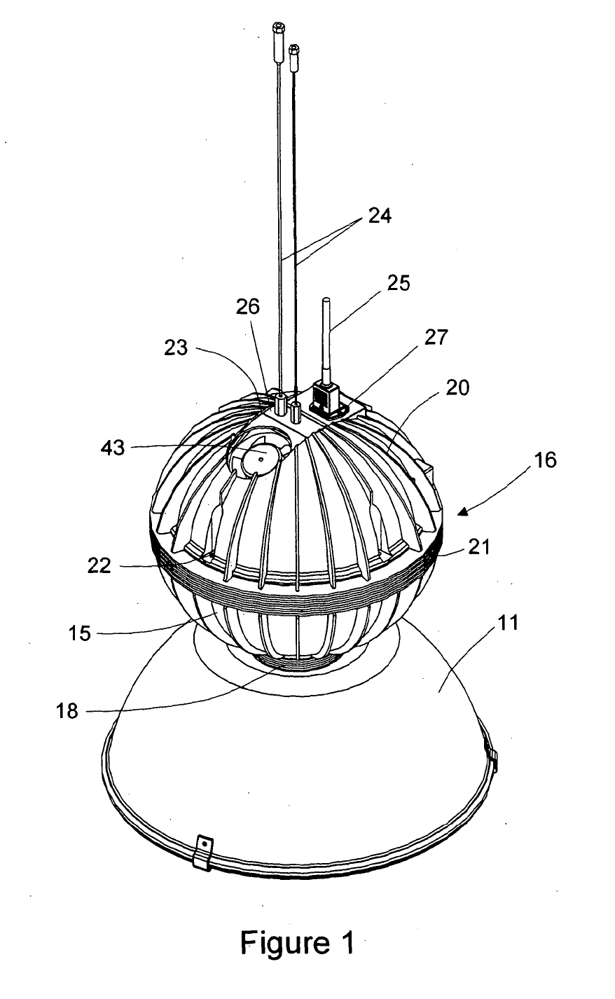

FIG. 1 is a perspective view of a luminaire in accordance with the invention;

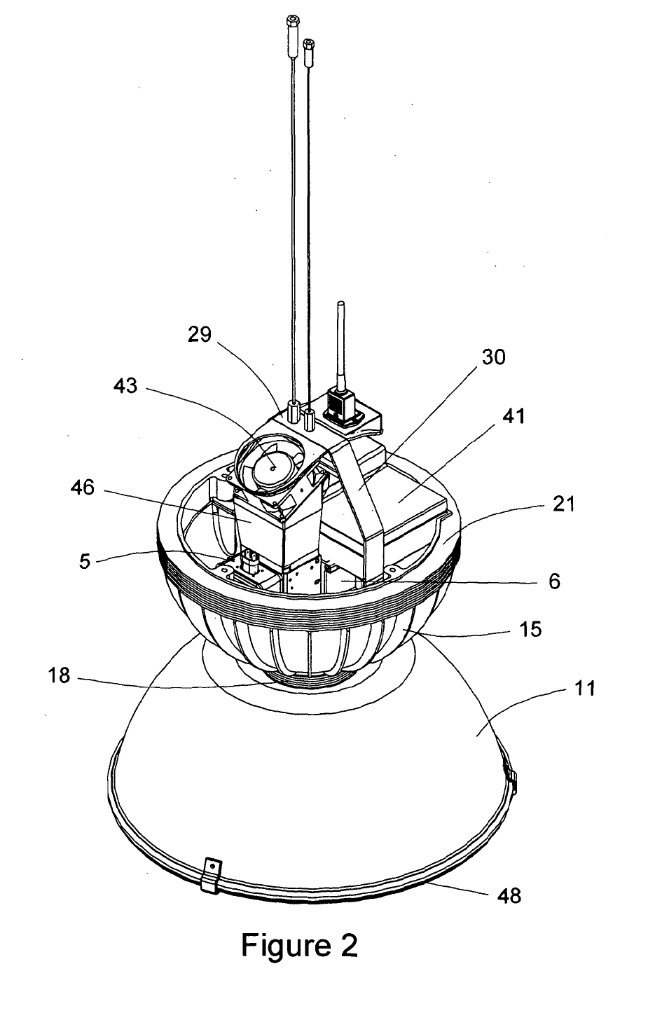

FIG. 2 is a view similar to FIG. 1, with an upper shell of the luminaire's casing removed;

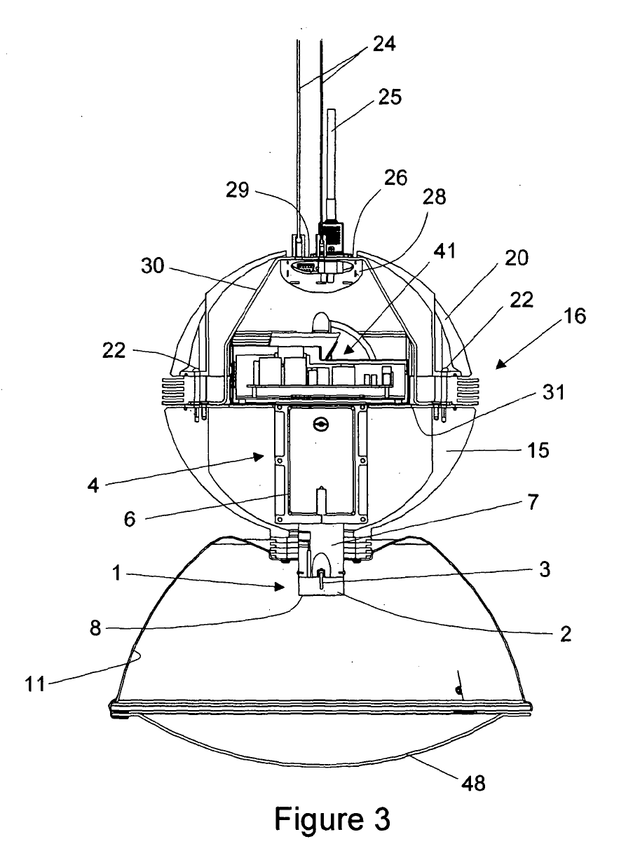

FIG. 3 is a central cross-sectional side view of the luminaire;

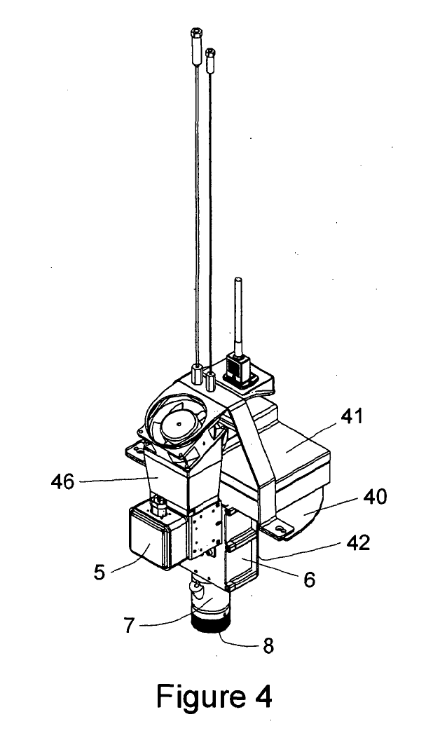

FIG. 4 is a view similar to FIG. 2, but with a lower shell and reflector removed;

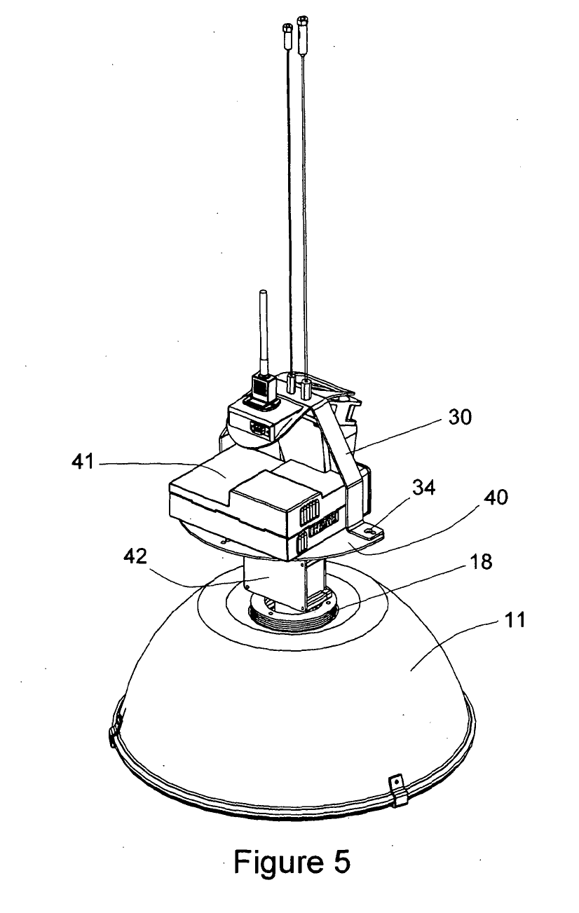

FIG. 5 is a perspective view from the other side, with the reflector shown, but unsupported;

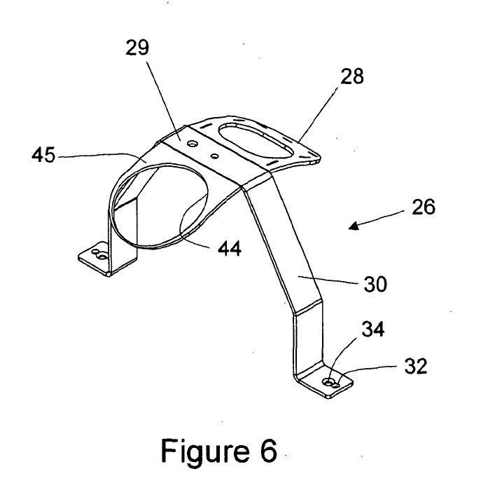

FIG. 6 is a perspective view of an invert-U support pressing of the luminaire;

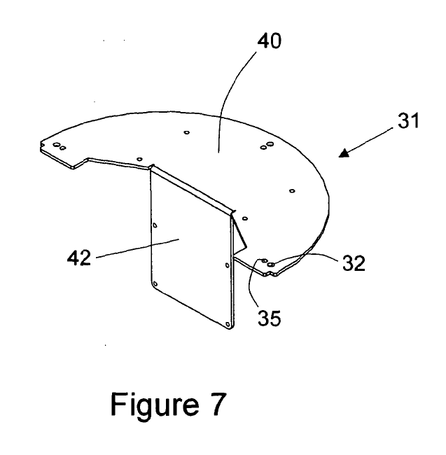

FIG. 7 is a perspective view of a platform support pressing of the luminaire;

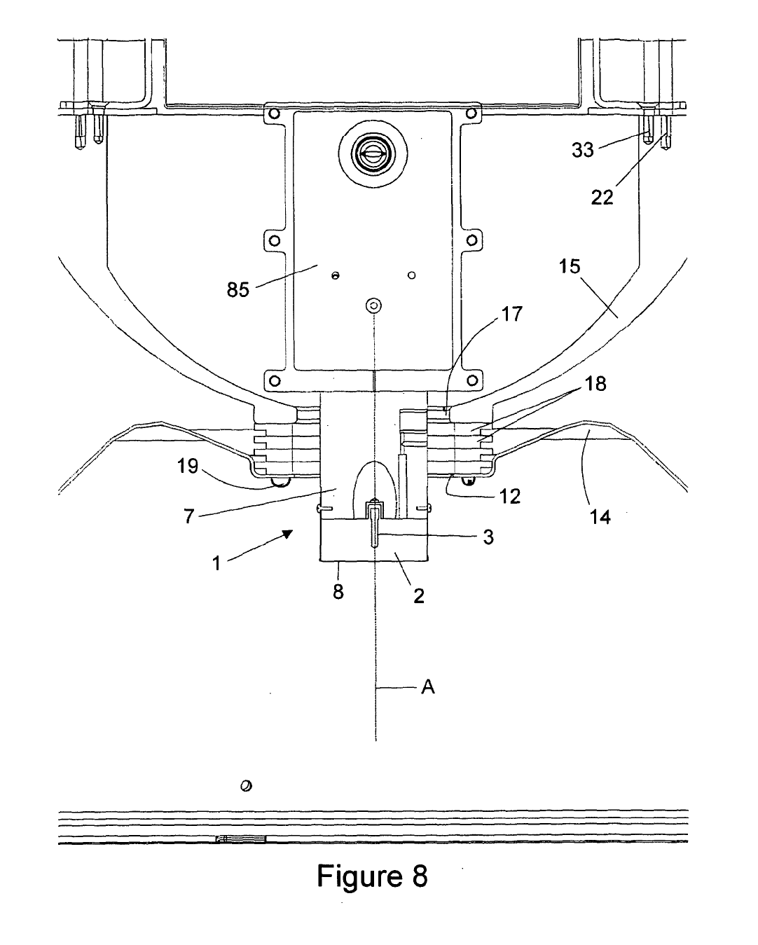

FIG. 8 is a scrap view in more detail than FIG. 3 of the connection of the reflector to the lower shell; and

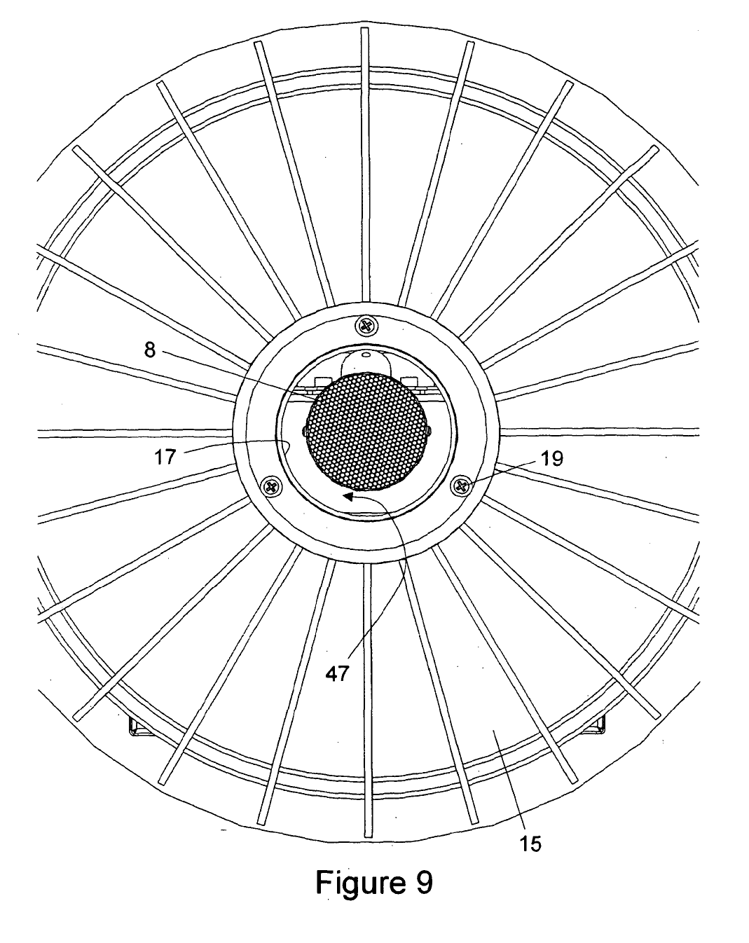

FIG. 9 is an underneath view of the components shown in FIG. 8, but with the reflector removed.

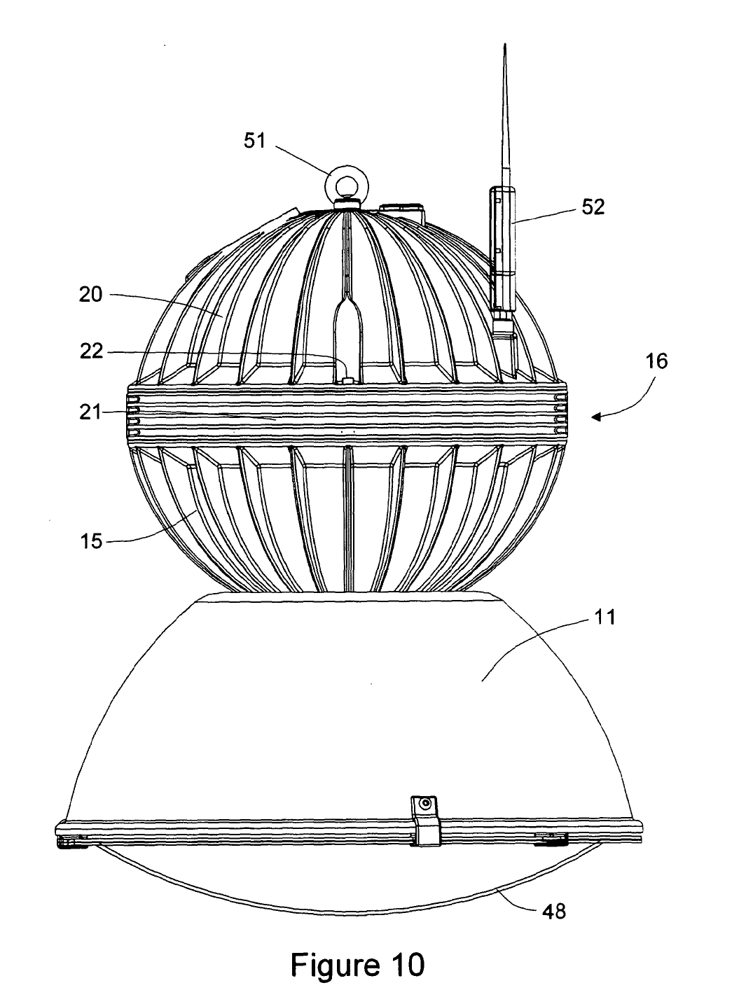

FIG. 10 is a side view of an alternative embodiment of the luminaire including a support fixture and wireless unit for remote control.

Referring to the drawings, the luminaire thereshown has a light source 1 in the form of a quartz crucible 2, having a plasma void 3, as described in Our LER Application. The crucible and its associated power supply 4 will not be described in detail, except to mention the following few details. The power supply has a magnetron for providing microwaves for generating the plasma in the void the magnetron having a case 5 providing the magnetron with physical structure. The components, via which the microwaves are transmitted from the magnetron to the void, and which have their own physical structure, are an air wave guide 6 connected below the magnetron case and a connector 7 connected below the wave guide. The plasma crucible is fitted to the bottom of the connector and is enclosed by a Faraday cage 8. The magnetron case 5, air wave guide 6, connector 7, crucible 2 and Faraday cage 8 all form a single assembly.

Arranged with the crucible at its focal point is a reflector 11. It has a central aperture 12, through which the assembly and in particular the connector 7 extends. It should be noted the reflector is shaped with the aperture 12 further from the power supply 4 in the direction of the luminaire's central axis A than a set-back portion 14 of the reflector surface closest to the power supply. The set-back arrangement of the portion 14 enables more light from the crucible to be reflected forwards than if the reflector curved forwards from the aperture 12.

A lower, hemispherical shell 15 of a casing 16 for the power supply supports the reflector at a similar aperture 17, with the interposition of one or more focus adjusting spacers 18. The reflector is fixed to the shell with screws 19. The lower shell curves up and away from the reflector hemispherically, enclosing the power supply within its bowl.

An upper, hemispherical shell 20 is provided on top of the lower shell, with an “equator” spacer 21 between them. Screws 22 fix these three parts together. It will be noted that in this embodiment, as shown, the casing 16 so formed does not support the power supply. Rather independent support for the power supply and the casing is provided. This enables the casing to be of light material. The support will now be described.

The “polar” part of the upper shell has an oblong aperture 23, giving access for support cables 24 and a power supply cable 25 to an invert U steel pressing 26. The power supply cable is plugged into a socket 27 supported on a lug 28 of the pressing at one end of the aperture. The cables are attached to a central portion 29 of the pressing, from which the lug extends. Limbs 30 of the pressing extend down to the equatorial region of the casing and are secured—by the screws 22—to a platform pressing or sub-frame 31. Inwards of the screws 22 and apertures 32 therefor in both pressings, secondary countersink screws 33 engage in countersunk holes 34 in the pressing 26, pass through complementary holes 35 in the platform pressing and hold fast in the lower shell. The screws are countersunk to allow the equator piece to abut the pressing at recesses 36 in the underside of the equator piece. Thus the cables support the pressings and the screws support the lower shell from the pressings and the lower shell supports the reflector.

The platform pressing has a platform 40 extending to one side on which control and drive circuitry 41 for the magnetron is carried. A flange 42 extends down from the platform centrally and has the air waveguide secured to it. Since the magnetron and the crucible are connected to the waveguide, the assembly of components contributing to the light generation are supported from the platform independently of the casing, except that the lower shell has the screws 22,33 threaded into it, whereby the pressing 26 is attached to the platform 40.

A cooling fan 43 is mounted at the top of the casing, beneath an aperture 44 in a second lug 45, extending from the invert-U pressing oppositely from the lug 28. The motor is actually supported by a duct 46, extending up from the magnetron. The duct leads air flow to cooling fins of the magnetron. Thence, it flows down to and through the annular gap 47 formed by the apertures 12, 17 in the reflector and the lower shell with the connector 7. Thus the connector is cooled and the crucible with its Faraday cage, which together run hotter, is also cooled. The cooling air exits the luminaire via gaps at the bottom of the reflector between the reflector and a transparent cover 48.

It will be appreciated that the above described embodiment has the following advantages beyond that of effective cooling with a single airflow of both the magnetron and the crucible:
providing the reflector with a portion extending back from its aperture receiving the crucible enables more light to be gathered from the plasma in the crucible and projected forwards in a substantially collimated way than if the reflector curved forwards from its aperture;
providing the spacers between the casing and the reflector provides a more convenient means of adjusting the focus of the reflector, as between a tight beam for illumination from height and a more diffuse beam for illumination from a lower level. The arrangement compares favourably to the more conventional focus adjustment in which the position of a light source in its reflector is adjusted by packing the position of the light source internally of the luminaire.

The invention is not intended to be restricted to the details of the above described embodiment. For instance, where the casing is of material of sufficient strength, such as light alloy or engineering plastics material, a support fixture typically an eye can be provided at the polar part of the upper shell for support and suspension of the entire luminaire, as shown in FIG. 10. Also shown in FIG. 10 is a wireless unit 52 for remote control of the luminaire. In contrast, the arrangement of the embodiment above allows the use of a lower strength casing, such as normal strength plastics material. The casing can be relieved of all load bearing by providing a lower pressing (not shown) similar to the pressing 26 extending down from sub-frame pressing 31 to the casing aperture 17, where the reflector can be bolted through the lower hemisphere to the lower pressing.

1-18. (canceled)

19. A luminaire having:
a plasma light source powered by High Frequency (HF) power;
a HF power supply having a physical structure,
the light source and the HF-power-supply physical structure being connected together as an assembly;
a housing for the HF power supply, the said assembly and the housing being fastened together and the housing having:
an aperture through which the said assembly extends with cooling air flow clearance and
a cooling air fan arranged at an opening in the housing for drawing air in (or out) for cooling of the HF power supply and passage out (or in) via the aperture and past the light source; and
a reflector for at least substantially collimating light from the light source fastened to the housing at the aperture and the reflector having its own aperture through which the said assembly extends, with the light source arranged within the reflector.

20. A luminaire according to claim 19, wherein the reflector has a set back portion extending back towards the said assembly from the reflector's fastening position on the housing.

21. A luminaire according to claim 19, including one or more spacers between the reflector and the housing at the reflector's fastening position on the housing for adjusting focus of the collimated light.

22. A luminaire according to claim 19, including:
luminaire supporting means fast with the housing and
means for supporting the said assembly from the luminaire supporting means via the housing.

23. A luminaire according to claim 22, wherein the luminaire supporting means is an eye fast with the housing at an upper region of the housing.

24. A luminaire according to claim 22, wherein the means for supporting the said assembly comprises a sub-frame interconnecting the assembly and the housing, the sub-frame being connected to the assembly at the HF-power-supply physical structure.

25. A luminaire according to claim 19, including:
luminaire supporting means fast with the said assembly and
means for supporting the housing from the luminaire supporting means.

26. A luminaire according to claim 25, wherein the luminaire supporting means is an eye fast an invert U member fast with the assembly.

27. A luminaire according to claim 25, wherein the means for supporting the said housing comprises a sub-frame interconnecting the housing and the assembly, the sub-frame being connected to the assembly at the HF-power-supply physical structure.

28. A luminaire according to claim 24, wherein the sub-frame is connected to the housing at a junction between and upper and lower parts of the housing.

29. A luminaire according to claim 27, wherein the sub-frame is connected to the housing at a junction between and upper and lower parts of the housing.

30. A luminaire according to claim 24, wherein the sub-frame is connected to the housing at the reflector's fastening position on the housing.

31. A luminaire according to claim 27, wherein the sub-frame is connected to the housing at the reflector's fastening position on the housing.

32. A luminaire according to claim 19, including a cooling air duct from the fan to the HF-power-supply physical structure.

33. A luminaire according to claim 19, wherein the HF-power-supply physical structure is the casing of a magnetron.

34. A luminaire according to claim 19, including a matching circuit between the HF power supply and the light source, the matching circuit having its own physical structure included in the said assembly.

35. A luminaire according to claim 32, including a connector between the matching circuit and the light source, the connector having its own physical structure included in the said assembly.

36. A luminaire according to claim 19, including a drive circuit for the HF power supply and with the HF-power-supply physical structure.

37. A luminaire according to claim 36, including:
luminaire supporting means fast with the housing and
means for supporting the said assembly from the luminaire supporting means via the housing and wherein the means for supporting the said assembly comprises:
a sub-frame interconnecting the assembly and the housing, the sub-frame being connected to the assembly at the HF-power-supply physical structure, the sub-frame supporting the drive circuit is the sub-frame where provided.

38. A luminaire according to claim 36, including:
luminaire supporting means fast with the said assembly and
means for supporting the housing from the luminaire supporting means
wherein the means for supporting the said assembly comprises:
a sub-frame interconnecting the housing and the assembly, the sub-frame being connected to the assembly at the HF-power-supply physical structure, the sub-frame supporting the drive circuit is the sub-frame where provided.

39. A luminaire according to claim 19, wherein the light source has:
a solid plasma crucible of material which is transparent or translucent for exit therefrom, the plasma crucible having a sealed void in the plasma crucible,
a Faraday cage surrounding the plasma crucible, the cage being at least partially light transmitting for light exit from the plasma crucible, whilst being microwave enclosing,
a fill in the void of material excitable by microwave energy to form a light emitting plasma therein, and
an antenna arranged within the plasma crucible for transmitting plasma-inducing microwave power to the fill;
the arrangement being such that:
light from a plasma in the void can pass through the plasma crucible and radiate from it via the cage to the reflector and
cooling air flows past the crucible.
